(19) United States
(12) Patent Application Publication
(10) Pub. No.: US 2021/0037180 A1
(43) Pub. Date: Feb. 4, 2021

(54) PHOTOGRAPHY DEVICE STATUS FEEDBACK METHOD, PHOTOGRAPHY DEVICE, AND PORTABLE ELECTRONIC DEVICE

(71) Applicant: SZ DJI TECHNOLOGY CO., LTD., Shenzhen (CN)

(72) Inventor: Jun MA, Shenzhen (CN)

(21) Appl. No.: 17/075,112

(22) Filed: Oct. 20, 2020

Related U.S. Application Data
(63) Continuation of application No. PCT/CN2018/085062, filed on Apr. 28, 2018.

(51) Int. Cl. H04N 5/232; G06F 3/16; H04N 5/225

(52) U.S. Cl. CPC H04N 5/23222; H04N 5/23216; G10L 15/22; H04N 5/2253; G06F 3/165

(57) ABSTRACT

A status feedback method includes obtaining a feedback instruction for instructing to feed back a status of a photography device and outputting status information of the photography device by sound according to the feedback instruction.

### CROSS-REFERENCE TO RELATED APPLICATION

This application is a continuation of International Application No. PCT/CN2018/085062, filed Apr. 28, 2018, the entire content of which is incorporated herein by reference.

### TECHNICAL FIELD

The present disclosure relates to the field of photography device and, more particularly, to a photography device status feedback method, a photography device, a portable electronic device, and a readable storage medium.

### BACKGROUND

Currently, use of photos or videos to record life has become a hot spot for people. For example, in sport scenes, such as skiing, moto racing, or skydiving, a camera can be used for image photographing or video recording to record the scene during exercise.

However, in a motion state, when relevant information of the camera is displayed on a screen, the screen shakes relative to a user, and the distribution of the information on the screen is relatively dispersive. The user cannot easily obtain the relevant information of the camera.

### SUMMARY

One aspect of the present disclosure provides a status feedback method. The method includes obtaining a feedback instruction for instructing to feed back a status of a photography device, and outputting status information of the photography device by sound according to the feedback instruction.

Another aspect of the present disclosure provides a photography device. The photography device includes a processor. The processor is configured to obtain a feedback instruction for instructing to feed back a status of the photography device and output status information of the photography device by sound according to the feedback instruction.

Another aspect of the present disclosure provides a portable electronic device. The portable electronic device includes a photography device and a support pole. The photography device includes a processor. The processor is configured to obtain a feedback instruction for instructing to feed back a status of the photography device and output status information of the photography device by sound according to the feedback instruction. The photography device is configured to be mounted at the support pole.

### BRIEF DESCRIPTION OF THE DRAWINGS

FIG. 1 illustrates an exemplary photography device status feedback method according to an embodiment of the present disclosure.

FIG. 2 illustrates another exemplary photography device status feedback method according to another embodiment of the present disclosure.

FIG. 3 illustrates another exemplary photography device status feedback method according to another embodiment of the present disclosure.

FIG. 4 illustrates another exemplary photography device status feedback method according to another embodiment of the present disclosure.

FIG. 5 illustrates another exemplary photography device status feedback method according to another embodiment of the present disclosure.

FIG. 6 illustrates another exemplary photography device status feedback method according to another embodiment of the present disclosure.

FIG. 7 illustrates another exemplary photography device status feedback method according to another embodiment of the present disclosure.

FIG. 8 illustrates another exemplary photography device status feedback method according to another embodiment of the present disclosure.

FIG. 9 illustrates another exemplary photography device status feedback method according to another embodiment of the present disclosure.

FIG. 10 illustrates another exemplary photography device status feedback method according to another embodiment of the present disclosure.

FIG. 11 illustrates another exemplary photography device status feedback method according to another embodiment of the present disclosure.

FIG. 12 illustrates another exemplary photography device status feedback method according to another embodiment of the present disclosure.

FIG. 13 illustrates another exemplary photography device status feedback method according to another embodiment of the present disclosure.

FIG. 14 illustrates an exemplary photography device consistent with various embodiments of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The terms used in this disclosure are only for the purpose of describing specific embodiments, and are not intended to limit the application. The singular forms of “a,” “said” and “the” used in this application and the appended claims are also intended to include plural forms, unless the context clearly indicates other meanings. It should also be understood that the term “and/or” used herein refers to and includes any or all possible combinations of one or more associated listed items. Unless otherwise indicated, similar words such as “front,” “rear,” “lower” and/or “upper” are only for convenience of description, and are not limited to one position or one spatial orientation. “Connected” or “coupled” and other similar words are not limited to physical or mechanical connections, and can include electrical connections, whether direct or indirect.

The present disclosure provides a photography device status feedback method. The method may be applied to, but is not limited to, a photography device in sport scenes, such as skiing, motor racing, or skydiving. In various embodiments, the photography device may be handheld, worn on a user's head or arm, mounted at a sports tool such as a ski car, a racing car, or a parachute, or mounted at a handheld photography pole or another handheld tool. In these sport scenes, the user cannot view the photography device to obtain status information of the photography device. By using the photography device status feedback method provided by the present disclosure, the user may obtain the status information of the photography device through voice played by the photography device in a sport scene.

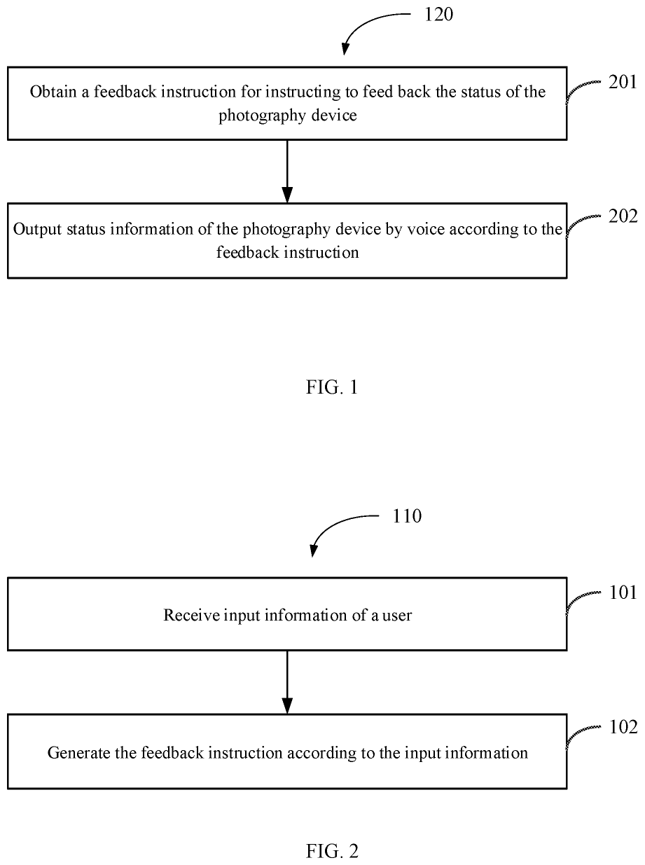

FIG. 1 illustrates an exemplary photography device status feedback method according to an embodiment of the present disclosure. The method may be applied to a photography device. As illustrated in FIG. 1, the method includes the following processes.

At 110, a feedback instruction for instructing to feed back status information of the photography device is received.

In one embodiment, a triggering mode of the feedback instruction of the photography device may include input triggering and/or automatic triggering. The input triggering may be triggering generated by a user inputting information to the photography device. The automatic triggering may be triggering generated by the photography device itself.

In one embodiment, the input triggering may include, but is not limited to, at least one of voice triggering, touch screen triggering, button triggering, gesture triggering, or timing triggering. The voice triggering may be triggering generated by voice input by the user to the photography device. The touch screen triggering may be triggering generated by the user's touch-control action on a screen of the photography device. The button triggering may be triggering generated by the user's press action on a physical button of the photography device. The gesture triggering may be triggering generated by the user's gesture at a certain distance from the photography device. The timing triggering may be triggering generated by time information input by the user.

Correspondingly, in various embodiments, based on the above different triggering modes, the photography device may adopt at least one of following configurations. The photography device may include a microphone for acquiring voice input by the user. The photography device may include a screen for acquiring the touch-control action input by the user, for displaying images photographed by the photography device, and/or for other control operations on the photography device. The photography device may include physical buttons for realizing the user's pressing action with respect to the physical buttons. The button triggering generated by the user's pressing action with respect to the physical buttons may be button triggering generated by a single physical button or button triggering generated by a combination of several physical buttons. The photography device may include a camera for acquiring the user's gesture. Other methods for acquiring the user's gesture may also be used if possible in actual applications. The photography device may include a timer for generating the timing triggering according to the time information input by the user.

The voice triggering mode may relatively liberate the user's manual operation and may be good for the photography device to perform corresponding actions according to the user's intention when the photography device is too small or the user is inconvenient to perform the manual operation currently. The gesture triggering mode may be good for the photography device to perform corresponding actions according to the user's intention when a distance from the photography device is too large, when the voice recognition result is bad because of noisy environment, or when the user is inconvenient to perform the manual operation. The button triggering mode may need the user's manual operation but may have low requirements on a size of the photography device when the user can touch the photography device, and may have a high accuracy, and a quick response efficiency. The touch screen triggering mode may still require the user's manual operation but may have a low requirement on a size of a screen compared to viewing corresponding information on the screen of the photography device. Further, the touch screen triggering mode may increase diversity and fun of the input triggering, and meet the user's needs for the touch screen triggering in non-sport scenes. In some sport scenes when the manual operation is impossible, the triggering modes that do not need the user's manual operation may be selected. In some other sports scenes where the manual operation is possible, such as skydiving, running, or gliding, multi-function requirement of the photography device may be met by adding some triggering modes that have low requirements on the manual operation.

In one embodiment, the triggering mode of the feedback instruction may be the input triggering. Correspondingly, as illustrated in FIG. 2, obtaining the feedback instruction for instructing to feed back the status of the photography device (110) includes receiving the user's input information (101) and generating the feedback instruction according to the input information (102).

The user's input information may include at least one of voice input information, touch screen input information, button input information, gesture input information, or timing input information. The voice input information may be the voice information input by the user through the microphone of the photography device. The touch screen input information may be the user's touch input information by touching the screen of the photography device. The button input information may be button input information when the user clicks the physical buttons of the photography device. The gesture input information may be, for example, user gesture information collected by a camera of the photography device. The timing input information may be time period information or time point information input by the user. Correspondingly, when the information input by the user is the voice input information, the triggering mode of the feedback instruction may be the voice triggering. When the information input by the user is the touch screen input information, the triggering mode of the feedback instruction may be the touch screen triggering. When the user input information is the button input information, the triggering mode of the feedback instruction may be the button triggering. When the information input by the user is the gesture input information, the triggering mode of the feedback instruction may be the gesture triggering. When the information input by the user is the timing input information, the triggering mode of the feedback instruction may be the timing triggering.

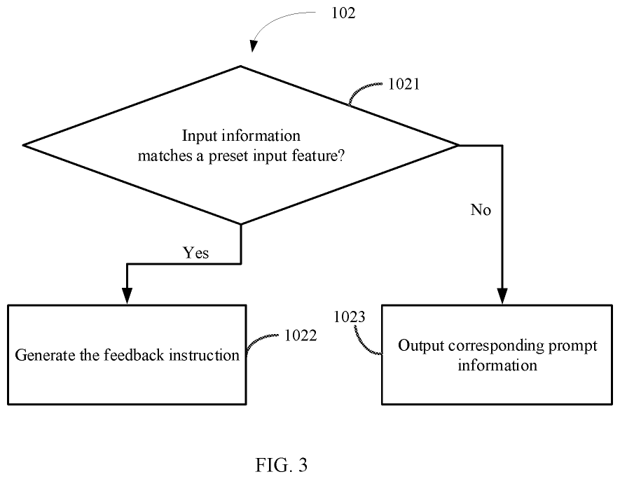

In one embodiment, as illustrated in FIG. 3, generating the feedback instruction according to the input information (102) includes determining whether the input information matches a preset input feature (1021), when the input information matches the preset input feature, generating the feedback instruction according to the input information (1022), and when the input information does not match the preset input feature, outputting corresponding prompt information (1023).

Specifically, the user's input information may be extensive. To improve processing efficiency of the photography device and avoid wasting computing resources because of input information parsing, the preset input feature may be set in advance, and the preset input feature may be compared to the user's input information. Correspondingly, the user's misoperation may be avoided and the user's intention of the input information may be quickly recognized. The preset input feature may be customized by the user or be set before the photography device leaves the factory.

In one embodiment, the input information received by the photography device may be the voice information, and correspondingly the preset input feature may be a preset voice feature including tone color, frequency, or energy. The photography device may extract the voice feature of the voice information, and determine whether the voice feature of the voice information matches the preset voice feature parameter. When the photography device determines that the voice feature of the voice information matches the preset voice feature parameter, the feedback instruction may be generated. In some embodiments, the preset input feature may also be a preset semantic feature including a number of sheets, power, memory, or other semantics. The photography device may extract the semantic feature of the voice information, and determine whether the semantic feature of the voice information matches the preset semantics. When the photography device determines that the voice feature of the voice information matches the preset semantics, the feedback instruction may be generated.

In one embodiment, the input information received by the photography device may be the touch screen input information, and correspondingly the preset input feature may be a preset touch-control feature including a touch screen pressure, a position being touched, movement status of preset label on the touch screen, or a pattern formed by the touch control. The photography device may acquire the touch-control feature corresponding to the touch screen input information, and determine whether the touch-control feature corresponding to the touch screen input information matches the preset touch-control feature. When the photography device determines that the touch-control feature corresponding to the touch screen input information matches the preset touch-control feature, it can generate a feedback instruction.

In one embodiment, the input information received by the photography device may be the button input information, and correspondingly the preset input feature may be a preset button function. The photography device may obtain a button function corresponding to the button input information, and determine whether the button function corresponding to the button input information matches the preset button function. When the photography device determines that the button function corresponding to the button input information matches the preset button function, it can generate a feedback instruction.

In one embodiment, the input information received by the photography device may be the gesture input information, and correspondingly the preset input feature may be a preset gesture posture. The photography device may acquire the gesture posture corresponding to the gesture input information, and determine whether the gesture posture corresponding to the gesture input information matches the preset gesture posture. When the photography device determines that the gesture posture corresponding to the gesture input information matches the preset gesture posture, it can generate a feedback instruction.

In one embodiment, when the photography device determines that the input information does not match the preset input feature, the mode that the photography device uses to output the prompt information may include, but is not limited to, making buzz sound, displaying preset voice information, or optoelectrical mode (such as a special optoelectrical color display).

In the present disclosure, after receiving the user's input information, the photography device may determine whether the user's input information matches the preset input feature. Correspondingly, the feedback instruction may be generated when the user's input information matches the preset input feature. Generation of the feedback instruction corresponding to the user's misoperation may be avoided. The user's experience may be improved. When the photography device determines that the input information does not match the preset input feature, the photography device may output the prompt information. The user may determine that the current input information is ineffective according to the prompt information of the photography device to adjust the input information in time.

Referring again to 110 in FIG. 1, when the triggering mode of the feedback instruction is the automatic triggering, the automatic triggering may include that when the photography device detects that the status information matches a preset condition, the feedback instruction may be generated to prompt the user about the status information of the photography device.

The status information may include, but is not limited to, operation status information or usage status information. The operation status information of the photography device may include, but is not limited to, operation status information of a central processing unit or operation status information of a graphics processing unit. The operation status information of the central processing unit may include, but is not limited to, power or temperature of the central processing unit. The operation status information of the graphic processing unit may include, but is not limited to, power or temperature of the graphic processing unit. The usage status information of the photography device may include, but is not limited to, at least one of remaining power, remaining usage time, a remaining number of photos, remaining video recording time, remaining memory space, a current photography mode, or a current focus mode.

In one embodiment, when the photography device detects that the operation status of the central processing unit does not match a preset operation status, it may be determined that the preset condition is met, and the feedback instruction may be generated. For example, a preset operation temperature range of the central processing unit may be about 20° C. to about 40° C. When the photography device detects that the operation temperature of the central processing unit is not in the preset operation temperature range, the feedback instruction may be generated.

In one embodiment, when the photography device detects that the operation status of the graphic processing unit does not match a preset operation status, it may be determined that the preset condition is met, and the feedback instruction may be generated. For example, a preset operation temperature range of the graphic processing unit may be about 20° C. to about 40° C. When the photography device detects that the operation temperature of the graphic processing unit is not in the preset operation temperature range, the feedback instruction may be generated.

In one embodiment, when the photography device detects that the remaining power is lower than a preset power threshold, it may be determined that the preset condition is met, and the feedback instruction may be generated. For example, the preset power threshold may be about 30%. When the photography device detects that the remaining power is lower than 30%, the feedback instruction may be generated.

In one embodiment, when the photography device detects that the remaining usage time is lower than a preset usage time threshold, it may be determined that the preset condition is met, and the feedback instruction may be generated. For example, the preset usage time threshold may be about 30 minutes. When the photography device detects that the remaining usage time is lower than 30 minutes, the feedback instruction may be generated.

In one embodiment, when the photography device detects that the remaining number of photos is lower than a preset remaining number of photos threshold, it may be determined that the preset condition is met, and the feedback instruction may be generated. For example, the preset remaining number of photos threshold may be about 20. When the photography device detects that the remaining number of photos is lower than 20, the feedback instruction may be generated.

In one embodiment, when the photography device detects that the remaining video recording time is lower than a preset remaining video recording time threshold, it may be determined that the preset condition is met, and the feedback instruction may be generated. For example, the preset remaining video recording time threshold may be about 15 minutes. When the photography device detects that the remaining video recording time is lower than 15 minutes, the feedback instruction may be generated.

In one embodiment, when the photography device detects that the remaining memory space is lower than a preset remaining memory space threshold, it may be determined that the preset condition is met, and the feedback instruction may be generated. For example, the preset remaining memory space threshold may be about 500 M. When the photography device detects that the remaining memory space is lower than 500 M, the feedback instruction may be generated.

In one embodiment, when the photography device detects that the current photography mode does not match a preset photography mode, it may be determined that the preset condition is met, and the feedback instruction may be generated. For example, the preset photography mode may be a landscape mode. When the photography device detects that the current photography mode is a portrait mode inconsistent with the preset landscape mode, the feedback instruction may be generated.

In one embodiment, when the photography device detects that the current focus mode does not match a preset focus mode, it may be determined that the preset condition is met, and the feedback instruction may be generated. For example, the preset focus mode may be a continuous focus mode. When the photography device detects that the current focus mode is a single focus mode inconsistent with the preset continuous focus mode, the feedback instruction may be generated.

For description purposes only, the above embodiments with certain preset conditions are used as examples to illustrate the present disclosure, and should not limit the scopes of the present disclosure. In various embodiments, the preset condition may be any suitable condition.

In some embodiments, the triggering mode of the feedback instruction may be the automatic triggering, and the photography device may automatically generate the feedback instruction periodically. Correspondingly, the photography device may automatically feed back the status information of the photography device periodically without the user's operation.

Referring again to FIG. 1, at 120, the status information of the photography device is output by sound (e.g., output by voice or vocally) according to the feedback instruction.

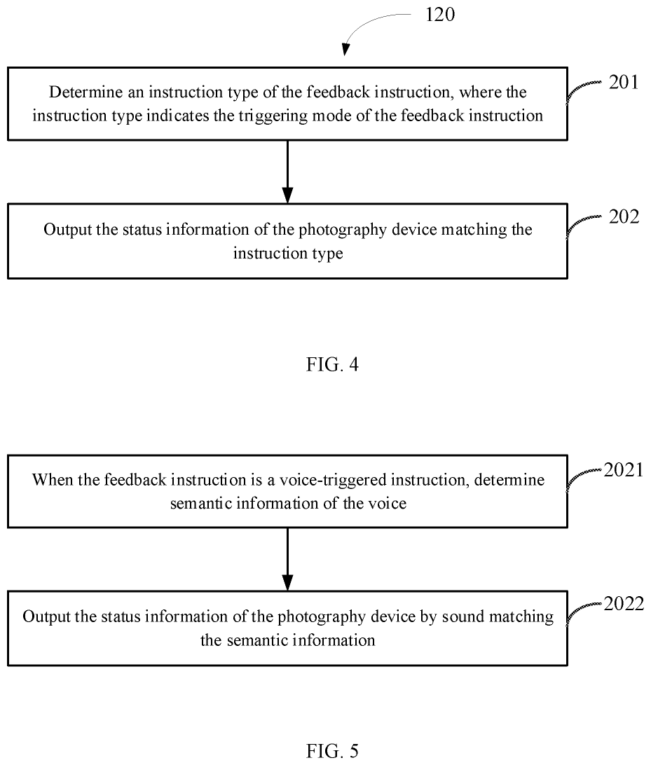

As illustrated in FIG. 4, in one embodiment, outputting the status information of the photography device by sound according to the feedback instruction (120) includes determining an instruction type of the feedback instruction (201) and outputting the status information of the photography device matching the instruction type according to the instruction type (202).

The instruction type may indicate the triggering mode of the feedback instruction.

The photography device may output by sound the status information matching the instruction type of the feedback instruction, such that the feedback of the status information may be pertinent and the user can select a corresponding triggering mode according to the status information to be acquired.

In one embodiment, the correspondence relationship between the instruction types of the feedback instruction and the status information of the photography device may be stored in the photography device in advance. The photography device may determine the status information to be fed back according to the instruction type of the feedback instruction and the correspondence relationship between the instruction type of the feedback instruction and the status information of the photography device.

In one embodiment, different feedback instructions may correspond to different types of status information.

In one embodiment, the triggering mode of the feedback instruction may be the input triggering. The correspondence relationship between the instruction types of the feedback instruction and the status information of the photography device stored in the photography device may include: the feedback instruction of the voice triggering matches the remaining power, the feedback instruction of the touch screen triggering matches the remaining usage time, the feedback instruction of the button triggering matches the remaining number of photos, the feedback instruction of the gesture triggering matches the remaining recording time, or the feedback instruction of the timing triggering matches multiple pieces of status information.

Correspondingly, in one embodiment, when the photography device determines that the feedback instruction is the voice triggering, the remaining power may be output by sound. When the photography device determines that the feedback instruction is touch screen triggering, the remaining usage time may be output by sound. When the photography device determines that the feedback instruction is the button triggering, the remaining number of photos may be output by sound. When the photography device determines that the feedback instruction is the gesture triggering, the remaining video recording time may be output by sound. When the photography device determines that the feedback instruction is the timing triggering, the matched multiple status information may be output by sound. For example, in one embodiment, the output of the matched multiple status information may include outputting the matched multiple status information by sound in a preset order. In one embodiment, the matched multiple status information may be output by sound in a preset order of the remaining usage time, the remaining number of photos, the current photography mode, and the current focus mode. For description purposes only, the above embodiments are used as examples to illustrate the present disclosure, and should not limit the scopes of the present disclosure. In various embodiments, the correspondence relationship between the feedback instructions with different types and the different types of status information may be any suitable correspondence relationship.

In one embodiment where the triggering mode of the feedback instruction is the automatic triggering, the feedback instruction of the automatic triggering may match one or more status information, and may be configured according to actual needs. The present disclosure has no limit on this.

In some embodiments, when the triggering mode of the feedback instruction of the photography device is the input triggering, the status information of the photography device matching the instruction content may be output by sound according to the instruction content of the feedback instruction. The photography device may feed back different types of status information according to different content of the feedback instructions with a same type of triggering mode. Correspondingly, the mode for feeding back the status information of the photography device may be diversified.

Specifically, when the feedback instruction is the instruction triggered by voice, the content of the feedback instruction may be semantic information of the voice. When the feedback instruction is an instruction triggered by the touch on the screen, the content of the feedback instruction may include but is not limited to at least one of the number of taps, the pressure of the touch, the function of the virtual button, the movement status of the preset label, or the pattern formed by the touch. When the feedback instruction is an instruction triggered by a button, the content of the feedback instruction may be the button function corresponding to the button. When the feedback instruction is a timing-triggered instruction, the content of the feedback instruction may be a preset instruction content corresponding to the timing triggering.

In one embodiment, when the triggering mode of the feedback instruction is the voice triggering, as illustrated in FIG. 5, outputting the status information of the photography device matching the instruction content by sound according to the instruction content of the feedback instruction includes when the feedback instruction is the instruction triggered by the voice, determining the semantic information of the voice (2021) and outputting the status information of the photography device matching the semantic information by sound (2022).

In one embodiment, correspondence relationship between the semantic information and the status information may be stored in the photography device. For example, a key word “remaining power” in the semantics may match the information of the remaining power, a key word “the remaining memory space” in the semantics may match the information of the remaining memory space, another keyword “remaining video recording time” in the semantics may match the information of the remaining video recording time, and another keyword “photography mode” in the semantics may match the information of the photography mode.

For the above correspondence relationship, when the photography device recognizes that the semantic information includes the key word “remaining power,” the photography device may output the current remaining power by sound. When the photography device recognizes that the semantic information of the voice includes the key word “the remaining memory space,” the current remaining memory space may be output by sound. When the photography device recognizes that the semantic information of the voice includes the key word “the remaining video recording time,” the current remaining video recording time of the photography device may be output by sound.

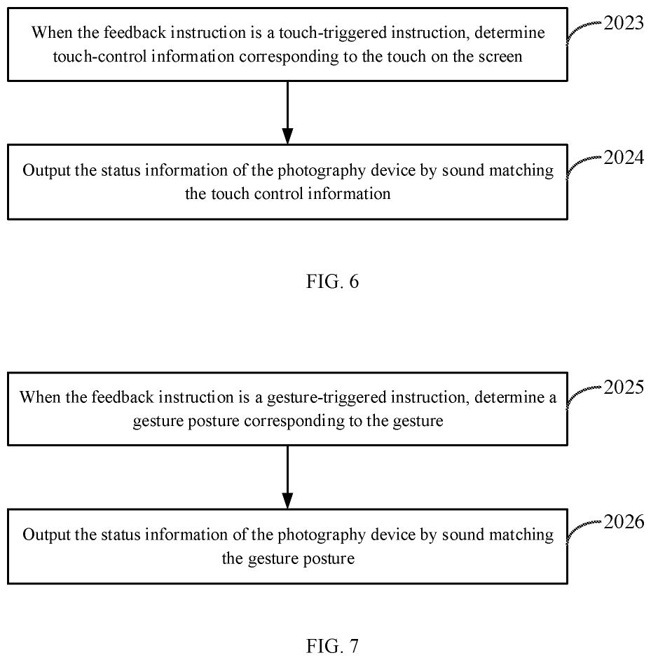

In another embodiment, when the triggering mode of the feedback instruction is the touch screen triggering, as illustrated in FIG. 6, outputting the status information of the photography device matching the instruction content by sound according to the instruction content of the feedback instruction includes when the feedback instruction is the instruction triggered by the touch on the screen, determining the touch-control information of the touch (2023) and outputting the status information of the photography device matching the touch-control information by sound (2024).

In some embodiments, the correspondence relationship between the different content of the touch control and the different types of status information may be stored in the photography device.

In one embodiment, different numbers of taps on the touch screen may match different types of status information. For example, one tap on the touch screen may match the remaining usage time information, a double tap on the touch screen may match the remaining number of photos, and consecutive taps on the touch screen for more than two times may match the remaining video recording time information. According to this correspondence relationship, when the photography device detects a tap on the touch screen, the current remaining usage time of the photography device may be output by sound. When the photography device detects a double tap on the touch screen, the current remaining number of photos of the photography device may be output by sound. When the photography device detects the consecutive taps on the touch screen for more than two times, the current remaining video recording time of the photography device may be output by sound. The above is only an example for description purpose only and should not limited the scopes of the present disclosure. In other embodiments, the correspondence relationship between the number of taps on the touch screens and different types of status information may be other relationships different from the foregoing examples.

In another embodiment, different touch pressures on the touch screen may match different types of status information. For example, a touch pressure in a first range may match the remaining power information, and a touch pressure in a second range may match the remaining memory space information. According to this correspondence relationship, when the photography device detects a touch pressure on the touch screen in the first range, the current remaining power of the photography device may be output by sound. When the photography device detects a touch pressure on the touch screen in the second range, the current remaining memory space of the photography device may be output by sound. The above is only an example for description purpose only and should not limit the scopes of the present disclosure. In other embodiments, the correspondence relationship between the different touch pressure on the touch screens and different types of status information may be other relationships different from the foregoing examples.

In another embodiment, virtual buttons with different functions may match different types status information. For example, a virtual button for feeding back the remaining power may match the remaining power information, a virtual button for feeding back the memory space may match the remaining memory space, and a virtual button for feeding back the operation status information of the central processing unit may match the operation status information of the central processing unit. According to this correspondence relationship, when the photography device detects a virtual button for feeding back the remaining power, the current remaining power of the photography device may be output by sound. When the photography device detects a virtual button for feeding back the memory space, the current remaining memory space of the photography device may be output by sound. When the photography device detects a virtual button for feeding back the operation status information of the central processing unit, the operation status information of the central processing unit of the photography device may be output by sound. The above is only an example for description purposes only and should not limit the scopes of the present disclosure. In other embodiments, the correspondence relationship between the different virtual buttons and different types of status information may be other relationships different from the foregoing examples.

In another embodiment, different movement states of a preset label may match different types of status information. For example, upward movement of the preset label may match the usage status information of the photography device, downward movement of the preset label may match the operation status information of the central processing unit, and leftward movement of the preset label may match the operation status information of the graphic processing unit. According to this correspondence relationship, when the photography device detects upward movement of the preset label, the current usage information of the photography device may be output by sound. When the photography device detects downward movement of the preset label, the operation status information of the central processing unit of the photography device may be output by sound. When the photography device detects leftward movement of the preset label, the operation status information of the graphic processing unit of the photography device may be output by sound. The above is only an example for description purposes only and should not limit the scopes of the present disclosure. In other embodiments, the correspondence relationship between the different movement states of the preset label and different types of status information may be other relationships different from the foregoing examples.

In another embodiment, different patterns formed by touch on the touch screen may match different types of status information. For example, a triangular pattern formed on the touch screen may match the usage status information of the photography device, a bar pattern formed on the touch screen may match the operation status information of the central processing unit, and an L-shape pattern formed on the touch screen may match the operation status information of the graphic processing unit. According to this correspondence relationship, when the photography device detects a triangular pattern formed on the touch screen, the current usage information of the photography device may be output by sound. When the photography device detects a bar pattern formed on the touch screen, the operation status information of the central processing unit of the photography device may be output by sound. When the photography device detects an L-shape pattern formed on the touch screen, the operation status information of the graphic processing unit of the photography device may be output by sound. The above is only an example for description purposes only and should not limit the scopes of the present disclosure. In other embodiments, the correspondence relationship between the different patterns formed on the touch screen and different types of status information may be other relationships different from the foregoing examples.

In another embodiment, when the triggering mode of the feedback instruction is the gesture triggering, as illustrated in FIG. 7, outputting the status information of the photography device matching the instruction content by sound according to the instruction content of the feedback instruction includes when the feedback instruction is the instruction triggered by the gesture, determining the gesture posture corresponding to the feedback instruction (2025) and outputting the status information of the photography device matching the gesture posture by sound (2026).

In the present disclosure, according to images captured by the camera, the photography device may recognize the gesture posture in the images as the gesture posture corresponding to the feedback instruction.

The correspondence relationship between different gesture postures and different types of status information may be stored in the photography device. In one embodiment, a gesture with five fingers spread out may match the remaining usage time information, a gesture with two fingers spread out may match the remaining number of photos, a gesture with three fingers spread out may match the remaining video recording time, and a fist gesture may match the remaining power. According to this correspondence relationship, when the photography device detects a gesture with five fingers spread out, the current remaining usage time of the photography device may be output by sound. When the photography device detects a gesture with two fingers spread out, the current remaining number of photos of the photography device may be output by sound. When the photography device detects a gesture with three fingers spread out, the current remaining video recording time of the photography device may be output by sound. When the photography device detects a fist gesture, the current remaining power of the photography device may be output by sound. The above is only an example for description purposes only and should not limit the scopes of the present disclosure. In other embodiments, the correspondence relationship between the different gesture posture and different types of status information may be other relationships different from the foregoing examples.

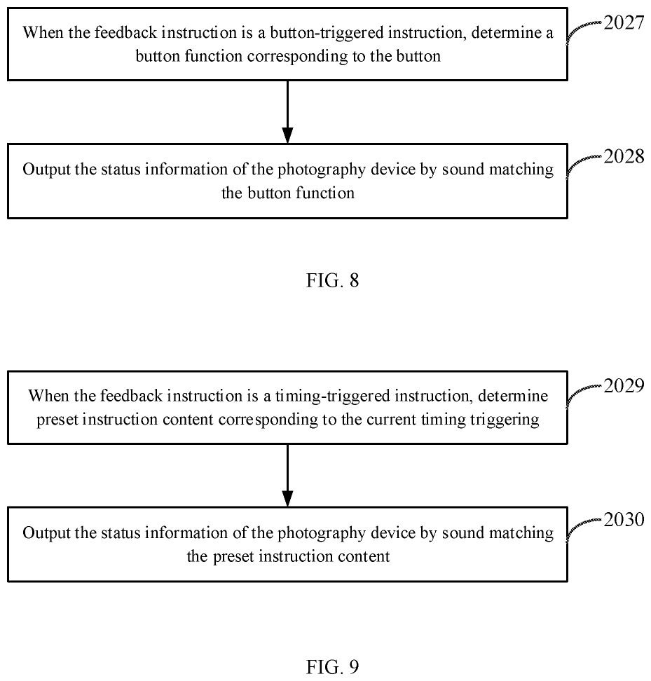

In another embodiment, when the triggering mode of the feedback instruction is the button triggering, as illustrated in FIG. 8, outputting the status information of the photography device matching the instruction content by sound according to the instruction content of the feedback instruction includes when the feedback instruction is the instruction triggered by the button, determining the button function corresponding to the button (2027) and outputting the status information of the photography device matching the button function (2028).

The correspondence relationship between different button functions and different types of status information may be stored in the photography device. In one embodiment, a button function for feeding back the remaining power may match the remaining power information, a button function for feeding back the remaining number of photos may match the information of the remaining number of photos, a button function for feeding back the remaining video recording time may match the information of the remaining video recording time, and a button function for feeding back the remaining power may match the information of the remaining power. According to this correspondence relationship, when the photography device detects a button for feeding back the remaining usage time, the current remaining usage time of the photography device may be output by sound. When the photography device detects a button for feeding back the remaining number of photos, the remaining number of photos of the photography device may be output by sound. When the photography device detects a button for feeding back the remaining video recording time, the current remaining video recording time of the photography device may be output by sound. When the photography device detects a button for feeding back the remaining power is tapped, the current remaining power of the photography device may be output by sound. The above is only an example for description purpose only and should not limit the scopes of the present disclosure. In other embodiments, the button function of a same button may correspond to multiple status information, or one button may correspond to multiple button functions and at least one of the multiple button functions may correspond to one or more button functions.

In another embodiment, when the triggering mode of the feedback instruction is the timing triggering, as illustrated in FIG. 9, outputting the status information of the photography device matching the instruction content by sound according to the instruction content of the feedback instruction includes when the feedback instruction is the timing-triggered instruction, determining preset instruction content corresponding to the current timing triggering (2029) and outputting the status information of the photography device matching the preset instruction content (2030).

The correspondence relationship between times of the timing triggering and the different preset instruction contents, and the correspondence relationship between the different preset instruction contents and different types of status information, may be stored in the photography device. The preset instruction content may be the usage status of the photography device, the operation status of the central processing unit, and/or the operation status of the graphic processing unit. The different times of the timing triggering may correspond to different statuses.

In one embodiment, a period of the timing triggering may be 10 minutes. The preset instruction content corresponding to the timing triggering 10 minutes after the photography device is started may be the remaining power. Correspondingly, the matched status information may be the remaining power information. The preset instruction content corresponding to the timing triggering 20 minutes after the photography device is started may be the remaining memory space. Correspondingly, the matched status information may be the remaining memory space information. The preset instruction content corresponding to the timing triggering 30 minutes after the photography device is started may be the remaining video recording time. Correspondingly, the matched status information may be the information of the remaining video recording time. The preset instruction content corresponding to the timing triggering 40 minutes after the photography device is started may be the remaining number of photos.

Correspondingly, the matched status information may be the information of the remaining number of photos. The preset instruction content corresponding to the timing triggering 50 minutes after the photography device is started may be the remaining usage time. Correspondingly, the matched status information may be the information of the remaining usage time.

According to this correspondence and matching relationship, when the photography device detects the feedback instruction when the photography device starts for 10 minutes, the current remaining power of the photography device may be output by sound. When the photography device detects the feedback instruction when the photography device starts for 20 minutes, the current remaining memory space of the photography device may be output by sound. When the photography device detects the feedback instruction when the photography device starts for 30 minutes, the current remaining video recording time of the photography device may be output by sound. When the photography device detects the feedback instruction when the photography device starts for 40 minutes, the current remaining number of photos of the photography device may be output by sound. When the photography device detects the feedback instruction when the photography device starts for 50 minutes, the current remaining usage time of the photography device may be output by sound. The above is only an example for description purposes only and should not limit the scopes of the present disclosure. In other embodiments, the correspondence relationship between time of the timing triggering and the different preset instruction content, and the correspondence relationship between the different preset instruction content and different types of status information, may be any suitable relationship. For example, in another embodiment, a change of a same status information of the photography device may be output by sound periodically.

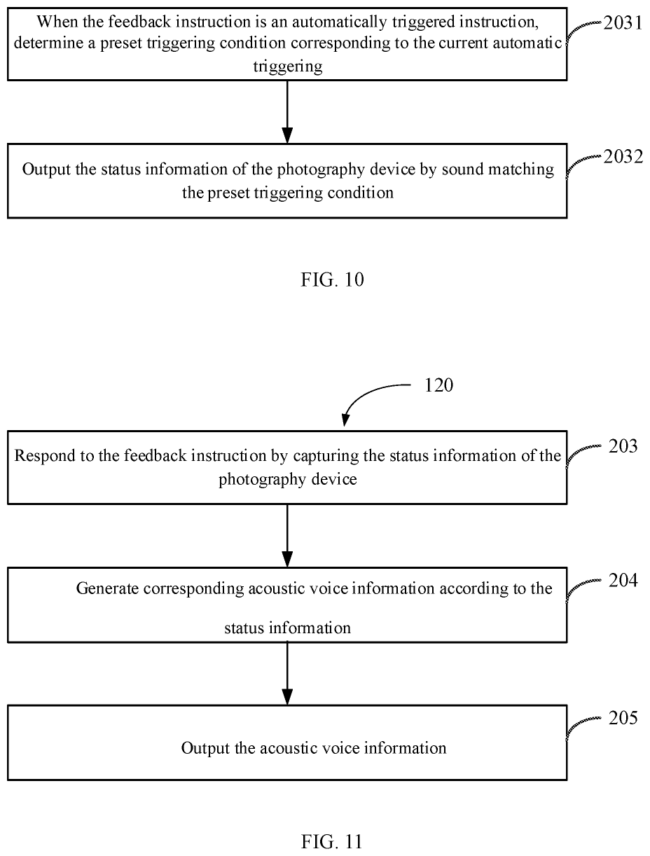

In another embodiment, when the triggering mode of the feedback instruction is the automatic triggering, as illustrated in FIG. 10, outputting the status information of the photography device matching the instruction content by sound according to the instruction content of the feedback instruction includes when the feedback instruction is the automatically triggered instruction, determining a preset triggering condition corresponding to the automatic triggering (2031) and outputting the status information of the photography device matching the preset triggering condition (2032).

The correspondence relationship between the different preset triggering conditions and different types of status information may be stored in the photography device.

In one embodiment, the preset triggering condition may be that the remaining power is lower than the preset power threshold, and the matched status information may be the remaining power information. The preset triggering condition may be that the remaining memory space is lower than the preset memory space, the matched status information may be the remaining memory space information. The preset triggering condition may be that the remaining usage time is lower than the preset usage time threshold, and the matched status information may be the information of the remaining usage time. The preset triggering condition may be that the remaining number of photos are less than the preset threshold of the number of photos and the matched status information may be the information of the remaining number of photos. The preset triggering condition may be that the remaining video recording time is lower than the preset video recording time threshold and the matched status information may be the information of the remaining video recording time.

According to this correspondence relationship, when the photography device detects that the preset triggering condition corresponding to the current automatic triggering is that the remaining power is lower than the preset power threshold, the current remaining power of the photography device may be output by sound. When the photography device detects that the preset triggering condition corresponding to the current automatic triggering is that the remaining memory space is lower than the preset memory space, the current remaining memory space of the photography device may be output by sound. When the photography device detects that the preset triggering condition corresponding to the current automatic triggering is that the remaining usage time is lower than the preset usage time threshold, the current remaining usage time of the photography device may be output by sound. When the photography device detects that the preset triggering condition corresponding to the current automatic triggering is that the remaining video recording time is lower than the preset video recording time threshold, the current remaining video recording time of the photography device may be output by sound. When the photography device detects that the preset triggering condition corresponding to the current automatic triggering is that the remaining number of photos are less than the preset threshold of the number of photos, the current remaining number of photos of the photography device may be output by sound. The above is only an example for description purposes only and should not limit the scopes of the present disclosure.

In one embodiment illustrated in FIG. 11, outputting the status information of the photography device by sound according to the feedback instruction (120) include responding to the feedback instruction to capture the status information of the photography device (203), generating acoustic voice information corresponding to the status information (204), and outputting the acoustic voice information (205).

In some embodiments, the photography device may convert the status information to corresponding digital voice information and then convert the digital voice information to the acoustic voice information.

In some embodiments, the photography device may collect the status information in real time according to the feedback instruction, and then convert the collected status information to the acoustic voice information to play. Correspondingly, the user may obtain the status information of the photography device in real time according to the acoustic voice information played by the photography device. The present embodiment may be applied to the feedback instruction with the input triggering and/or the automatic triggering.

In another embodiment, acoustic voice corresponding to the preset triggering condition may be stored in the photography device. The acoustic voice corresponding to the preset triggering condition may feed back the status information of the photography device. When the photography device detects that the status information of the photography device meets the preset triggering condition, the corresponding acoustic voice may be played directly without collecting the current status information of the photography device. The information processing of the photography device may be simpler. The present embodiment may be applied to the feedback instruction with the automatic triggering.

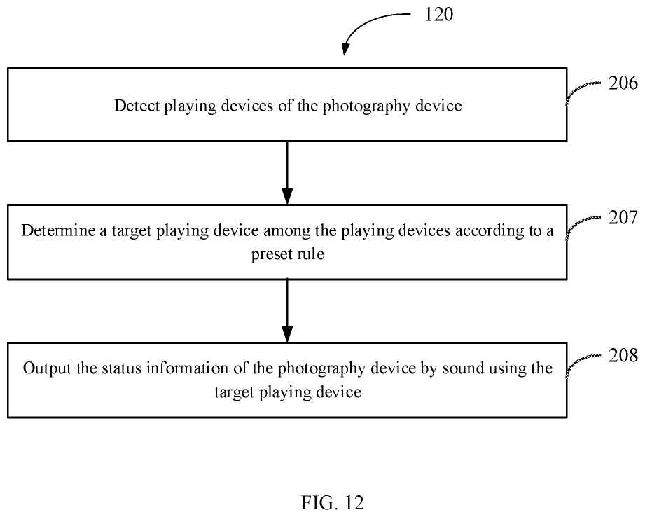

In another embodiment illustrated in FIG. 12, outputting the status information of the photography device by sound according to the feedback instruction (120) includes detecting playing devices of the photography device (206), determining a target playing device among the playing devices according to a preset rule (207), and outputting the status information of the photography device by sound using the target playing device (208).

The playing devices may include external playing devices connected to the photography device, or internal playing device of the photography device. The external playing devices may include at least one of an external speaker, a Bluetooth headset, or a wired headset. The internal playing devices of the photography device may include a speaker of the photography device.

In some embodiments, when multiple playing devices are detected, the target playing device may be determined according a preset play priority rule.

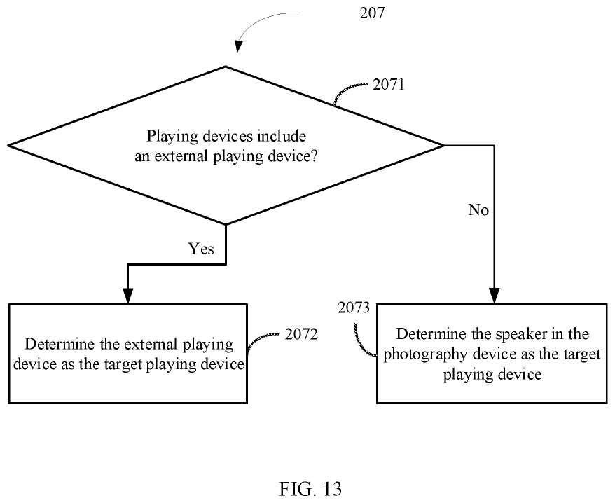

In one embodiment, as illustrated in FIG. 13, determining the target playing device among the playing devices according to the preset rule (207) includes determining whether the playing devices include an external playing devices (2071), when it is determined that the playing devices include the external playing device, determining the external playing device as the target playing device (2072), and when it is determined that the playing devices do not include the external playing device, determining the speaker of the photography device as the target playing device (2074).

In some embodiments, when it is determined that the playing devices include the external playing device, the external playing device may be used to play the status information of the photography device. When it is determined that the playing devices do not include the external playing device, the status information of the photography device may be played by the speaker of the photography device. A playing priority of the external playing device may be higher than a playing priority of the internal playing device in the photography device. When playing the status information of the photography device through the external playing device, the external playing device closer to the user may be preferred to play the status information of the photography device since the environment of the sport scenes may be noisy, to facilitate the transmission of the content played by the playing device into ears of the user.

In one embodiment, determining whether the playing devices include an external playing device may include: determining whether the photography device is connected to the external play device, such as detecting whether Bluetooth connection signal or Bluetooth starting signal (which can be considered default as the external Bluetooth headset) exist. The present embodiment is used as an example to illustrate the present disclosure for description purposes only, and should not limit the scopes of the present disclosure. In various embodiments of the present disclosure, any suitable detecting method may be used.

In the photography device status feedback method presented by the present disclosure, the photography device may output the status information of the photography device by sound according to the feedback instruction after receiving the feedback instruction for instructing to feed back the status of the photography device. Correspondingly, in the scenes where it is inconvenient to check the photography device, the user may acquire the status information of the photography device through the voice output by the photography device. The present method may have less requirement on the visual or manual operation of the user. The problems that the user cannot acquire the status information of the photography device conveniently because of the reasons including that the user cannot divert his eyesight in the sport scenes, that the user cannot see the screen of the photography device which is far from the user, that the screen of the photography device is too small to display more status information, or the user is inconvenient to manually operate to switch the photography device, may be alleviated. The user's experience may be improved.

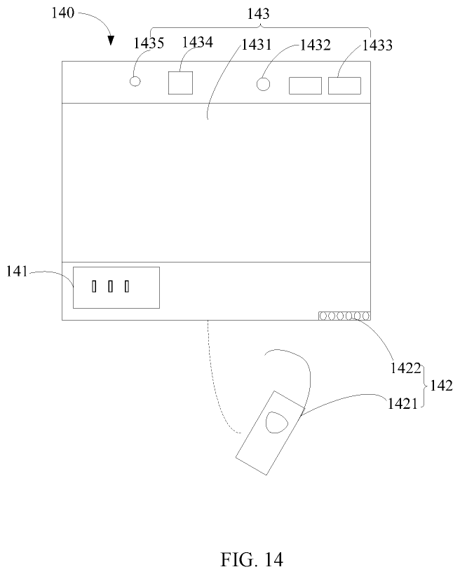

The present disclosure also provides a photography device. FIG. 14 shows an example photography device 140 consistent with the disclosure. The photography device 140 includes a processor 141. The processor 141 may be configured to obtain a feedback instruction for instructing to feed back the status of the photography device 140 and to output the status information of the photography device 140 by sound according to the feedback instruction.

In the photography device of the present disclosure, the photography device may output the status information of the photography device by sound according to the feedback instruction after receiving the feedback instruction for instructing to feed back the status of the photography device. Correspondingly, in the scenes where it is inconvenient to check the photography device, the user may acquire the status information of the photography device through the voice output by the photography device. The present method may have lower requirement on the visual or manual operation of the user. The problems that the user cannot acquire the status information of the photography device conveniently because of the reasons including that the user cannot divert his eyesight in the sport scenes, that the user cannot see the screen of the photography device which is far from the user, that the screen of the photography device is too small to display more status information, or the user is inconvenient to manually operate to switch the photography device (such as switch the interfaces of the photography device to check information of different interfaces), may be alleviated. Ease of the use of the photography device may be improved.

In one embodiment, a triggering mode of the feedback instruction of the photography device may include input triggering and/or automatic triggering.

In one embodiment, the input triggering may include, but not be limited to, at least one of voice triggering, touch screen triggering, button triggering, gesture triggering, or timing triggering.

In one embodiment, the processor 141 may be further configured to: determine an instruction type of the feedback instruction, and output by sound the status information of the photography device 140 matching the instruction type according to the instruction type.

In another embodiment, the processor 141 may be further configured to: according to the instruction content of the feedback instruction, output by sound the status information of the photography device 140 matching the instruction content.

In another embodiment, the processor 141 may be further configured to: when the feedback instruction is a voice-triggered instruction, recognize semantic information of the voice, and output by sound the status information of the photography device 140 matching the semantic information.

In another embodiment, the processor 141 may be further configured to: when the feedback instruction is an instruction triggered by the touch on the screen, determine the touch control information corresponding to the touch on the screen, and output by sound the status information of the photography device 140 matching the touch control information.

In one embodiment, the touch control information may include at least one of a number of tap, touch pressure, function of a virtual button, movement state of a preset label, or a pattern formed by the touch.

In another embodiment, the processor 141 may be further configured to: when the feedback instruction is an instruction triggered by a button, determine the button function corresponding to the button, and output by sound the status information of the photography device 140 matching the button function.

In another embodiment, the processor 141 may be further configured to: when the feedback instruction is an instruction triggered by gesture, output by sound the status information of the photography device 140 matching the gesture.

In another embodiment, the processor 141 may be further configured to: when the feedback instruction is a timing-triggered instruction, determine preset instruction content corresponding to the current timing triggering, and output by sound the status information of the photography device 140 matching the preset instruction content.

In another embodiment, the processor 141 may be further configured to: when the feedback instruction is an automatically triggered instruction, determine preset triggering condition corresponding to the current automatic triggering, and output by sound the status information of the photography device 140 matching the preset triggering condition.

In one embodiment, the processor 141 may be further configured to: detect playing devices 142 of the photography device 140, determine a target playing device among the playing devices 142 according to a preset rule, and output the status information of the photography device 140 by sound using the target playing device.

In one embodiment, the processor 141 may be further configured to determine whether the playing devices 142 include an external playing device 1421, when it is determined that the playing devices include the external playing device, determine the external playing device 1421 as the target playing device, and when it is determined that the playing devices 142 do not include the external playing device 1421, determine the speaker of the photography device as the target playing device. In some embodiments, the external playing devices 1421 includes a Bluetooth headset, which is used as an example to illustrate the present disclosure and should not limit the scopes of the present disclosure.

In one embodiment, the external playing devices 1421 may include at least one of an external speaker, a Bluetooth headset, or a wired headset.

In one embodiment, the processor 141 may be further configured to obtain input information from the user and generate the feedback instruction according to the input information. In one embodiment, as illustrated in FIG. 14, the photography device 140 further includes a receiver 143. The receiver 143 may be configured to receive the input information from the user and transmit the input information to the processor 141. As shown in FIG. 14, the receiver 143 includes, but is not limited to, a screen 1431, a microphone 1432, a physical button 1433, a timer 1434, and a camera 1435.

In one embodiment, the processor 141 may be further configured to: determine whether the input information matches a preset input feature, and generate the feedback instruction when the input information matches the preset input feature.

In one embodiment, the processor 141 may be further configured to: when the input information does not match the preset input feature, output corresponding prompt information. In one embodiment, the photography device 140 may further include an alarm (not shown in the figures). The alarm may be configured to receive the prompt information form the processor 141 and output the prompt information. For example, the alarm may be a vibrator, and the prompt information may be vibrating correspondingly. In another embodiment, the alarm may be the speaker 1422, and the prompt information may be voice information for playing accordingly. In some other embodiments, the alarm may be another suitable alarm such as a breathing light.

In one embodiment, the processor 141 may be further configured to: generate the feedback instruction periodically according to the input information.

In one embodiment, when the triggering mode of the feedback instruction is the automatic triggering, the processor 141 may be further configured to: when the status information of the photography device 140 meets a preset triggering condition, generate the feedback instruction.

In one embodiment, the processor 141 may be further configured to: respond to the feedback instruction to obtain the status information of the photography device 140, generate corresponding acoustic voice information according to the status information, and output the acoustic voice information.

In one embodiment, the status information of the photography device 140 may include at least one of operation status information and usage status information.

In one embodiment, the operation status information may include operation status information of a central processing unit and/or operation status information of a graphic processing unit. The usage status information may include at least one of remaining power, remaining usage time, remaining number of photos, remaining video recording time, remaining memory space, current photographic mode, or current focus mode.

For the embodiments of the photography device, the details can be referred to the various embodiments of the method provided by the present disclosure.

The present disclosure also provides a portable electronic device. The portable electronic device may include the photography device 141 provided by the present disclosure and a support pole. The photography device 141 may be mounted at the support pole.

The photography device and the support pole may be detachably connected, and the support pole may be a part used to be held in hand or worn on the head or arm of the user. For example, the support pole may be a hand-held pole, a hand-held gimbal, a helmet, a fixed strap.

The present disclosure also provides a computer-readable storage medium. Computer programs may be stored in the computer-readable storage medium. When the programs are executed by a processor, the photography device status feedback method described above may be performed.

In the present disclosure, the photography device may output the status information of the photography device by sound according to the feedback instruction after receiving the feedback instruction for instructing to feed back the status of the photography device. Correspondingly, in the scenarios where it is inconvenient to check the photography device, the user may acquire the status information of the photography device through the voice output by the photography device. The present method may have less requirement on the visual or manual operation of the user. The problems that the user cannot acquire the status information of the photography device conveniently because of reasons such as the user cannot divert his eyesight in the sport scenes, the user cannot see the screen of the photography device which is far from the user, the screen of the photography device is too small to display more status information, or the user is inconvenient to manually operate to switch the photography device, can be solved. The user's experience can be improved.

It should be noted that in this disclosure, relational terms such as “first” and “second” are only used to distinguish one entity or operation from another entity or operation, and do not necessarily require or imply there is any such actual relationship or sequence between these entities or operations. The terms “comprise,” “include” or any other variants thereof are intended to cover non-exclusive inclusion, so that a process, method, article or device including a series of elements not only includes those elements, but also includes other elements not explicitly listed, or also include elements inherent to such processes, methods, articles, or equipment. If there are no more restrictions, using the phrase “including a . . . ” preceding an element does not exclude the existence of other identical elements in the process, method, article, or equipment that includes the element.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A status feedback method comprising:
obtaining a feedback instruction for instructing to feed back a status of a photography device; and
outputting status information of the photography device by sound according to the feedback instruction.

2. The method according to claim 1, wherein:
a triggering mode of the feedback instruction includes at least one of input triggering or automatic triggering.

3. The method according to claim 2, wherein:
the input triggering includes at least one of voice triggering, touch screen triggering, button triggering, gesture triggering, or timing triggering.

4. The method according to claim 3, wherein outputting the status information of the photography device by sound according to the feedback instruction includes:
determining an instruction type of the feedback instruction that indicates the triggering mode of the feedback instruction, and outputting the status information of the photography device matching the instruction type by sound; or
outputting the status information of the photography device matching instruction content of the feedback instruction by sound.

5. The method according to claim 4, wherein outputting the status information of the photography device matching the instruction content by sound includes at least one of:
in response to the feedback instruction being triggered by a voice, determining semantic information of the voice and outputting the status information of the photography device matching the semantic information by sound;
in response to the feedback instruction being triggered by a touch on a screen, determining touch-control information corresponding to the touch and outputting the status information of the photography device matching the touch-control information by sound;
in response to the feedback instruction being triggered by a button, determining a button function corresponding to the button and outputting the status information of the photography device matching the button function by sound;
in response to the feedback instruction being triggered by a gesture, outputting the status information of the photography device matching the gesture by sound;
in response to the feedback instruction being a timing triggered instruction, determining preset instruction content corresponding to the current timing triggering and outputting the status information of the photography device matching the preset instruction content by sound; or
in response to the feedback instruction being an automatically triggered instruction, determining a preset triggering condition corresponding to current automatic triggering, and outputting the status information of the photography device matching the preset triggering condition by sound.

6. The method according to claim 5, wherein:
the touch control information includes at least one of a number of taps, a touch pressure, a function of a virtual button, a movement state of a preset label, or a pattern formed by the touch.

7. The method according to claim 1, wherein outputting the status information of the photography device by sound according to the feedback instruction includes:
detecting one or more playing devices of the photography device;
determining a target playing device among the one or more playing devices according to a preset rule; and
outputting the status information of the photography device by sound using the target playing device.

8. The method according to claim 7, wherein determining the target playing device among the one or more playing devices according to the preset rule includes:
determining whether the one or more playing devices include an external playing device;
in response to determining that the one or more playing devices include the external playing device, determining the external playing device as the target playing device; and
in response to determining that the one or more playing devices do not include the external playing device, determining a speaker of the photography device as the target playing device.

9. The method according to claim 8, wherein the external playing device includes at least one of an external speaker, a Bluetooth headset, or a wired headset.

10. The method according to claim 1, wherein:
a triggering mode of the feedback instruction is input triggering; and
obtaining the feedback instruction for instructing to feed back the status information of the photography device includes:
receiving input information of a user; and
generating the feedback instruction according to the input information.

11. The method according to claim 10, wherein generating the feedback instruction according to the input information includes:
determining whether the input information matches a preset input feature; and
in response to determining that the input information matches the preset input feature, generating the feedback instruction.

12. The method according to claim 11, further comprising:
in response to determining that the input information does not match the preset input feature, outputting corresponding prompt information.

13. The method according to claim 10, wherein generating the feedback instruction according to the input information includes:
generating the feedback instruction periodically according to the input information.

14. The method according to claim 1, wherein:
a triggering mode of the feedback instruction is automatic triggering; and
obtaining the feedback instruction for instructing to feed back the status information of the photography device includes:
in response to the status information of the photography device matching a preset triggering condition, generating the feedback instruction.

15. The method according to claim 1, wherein outputting the status information of the photography device by sound according to the feedback instruction includes:
responding to the feedback instruction to capture the status information of the photography device;
generating corresponding acoustic voice information according to the status information; and
outputting the acoustic voice information.

16. The method according to claim 1, wherein the status information of the photography device includes at least one of operation status information or usage status information.

17. The method according to claim 16, wherein:
the operation status information includes at least one of operation status information of a central processing unit or operation status information of a graphic processing unit; and
the usage status information includes at least one of remaining power, remaining usage time, a remaining number of photos, remaining video recording time, remaining memory space, a current photographing mode, or a current focus mode.

18. A photography device comprising:
a processor configured to:
obtain a feedback instruction for instructing to feed back a status of the photography device; and
output status information of the photography device by sound according to the feedback instruction.

19. A portable electronic device comprising:
a support pole; and
a photography device configured to be mounted at the support pole and including a processor configured to:
obtain a feedback instruction for instructing to feed back a status of the photography device; and
output status information of the photography device by sound according to the feedback instruction.
